(19) United States
(12) Patent Application Publication
(10) Pub. No.: US 2014/0256265 A1
(43) Pub. Date: Sep. 11, 2014

(54) METHOD FOR AUTONOMOUS RADIO NETWORK OPTIMIZATION USING STOCHASTIC APPROXIMATION

(71) Applicant: QUALCOMM INCORPORATED, San Diego, CA (US)

(72) Inventors: Bongyong Song, San Diego, CA (US); Samir Salib Soliman, Poway, CA (US)

(73) Assignee: QUALCOMM Incorporated, San Diego, CA (US)

(21) Appl. No.: 13/790,243

(22) Filed: Mar. 8, 2013

(51) Int. Cl. H04W 24/00

(52) U.S. Cl. CPC H04W 24/00
USPC 455/67.11

(57) ABSTRACT

A method of determining, within a radio network, an optimal value of at least one network parameter having an associated performance metric, the network having at least a base station and a user equipment (UE), the method including: providing a mathematical representation function (MRF) for the performance metric such that an optimal value for each of the at least one network parameter provides a result of zero in the MRF; making at least one noisy observation of the MRF from the network; and recursively updating the at least one network parameter based on the at least one noisy observation to obtain the optimal value for each of the at least one network parameter that provides the result of zero in the MRF.

### BACKGROUND

1. Field

The disclosure relates generally to the field to optimizing parameters in a radio network, and, in particular, relates to systems and methods for optimizing parameters in a radio network using stochastic approximation.

2. Background

Wireless communication systems have become an important manner by which many people worldwide have come to communicate. A wireless communication system may include a radio that network that provides communication for a number of mobile devices, each of which may be serviced by a base station. Examples of mobile devices include cellular phones, personal digital assistants (PDAs), handheld devices, wireless modems, laptop computers, personal computers, etc.

As wireless communication becomes more popular, system performance, such as throughput, handover success rate, and/or the like, must be increased. System performance can be improved via radio network optimization. Radio network optimization involves determining optimal values of various parameters, such as various thresholds (e.g., detection threshold, Eb/No target, etc.) and various timers (e.g., inactivity timers, time to trigger timers, etc.). These parameters are usually determined heuristically (manually) via simulations or intuitions and then fine tuned in the field. The determined values are typically applied globally (i.e., applied throughout the network).

### SUMMARY

A method of determining, within a radio network, an optimal value of at least one network parameter having an associated performance metric, the network having at least a base station and a user equipment (UE), the method may include, but is not limited to any one or combination of: obtaining a mathematical representation function (MRF) for the performance metric such that an optimal value for each of the at least one network parameter provides a result of zero in the MRF; making at least one noisy observation of the MRF from the network; and recursively updating the at least one network parameter based on the at least one noisy observation to obtain the optimal value for each of the at least one network parameter that provides the result of zero in the MRF. The at least one network parameter comprises one or more of a threshold parameter and a timer parameter.

In various embodiments, the threshold parameter is an Eb/No target threshold parameter.

In various embodiments, the threshold parameter is a signal detection threshold parameter.

In various embodiments, the timer parameter is a data inactivity timer parameter.

In some embodiments, the data inactivity timer comprises a data inactivity timer for Cell_FACH to idle state transition.

In various embodiments, the timer parameter is a time to trigger timer parameter.

In various embodiments, the at least one noisy observation is made by the UE.

In various embodiments, the at least one noisy observation is made by the base station.

In various embodiments, the at least one network parameter is recursively updated at the base station.

In various embodiments, the at least one network parameter is recursively updated at the UE.

In various embodiments, the at least one noisy observation is an average of more than one noisy observations.

An apparatus for determining, within a radio network, an optimal value of at least one network parameter having an associated performance metric, the network having at least a base station and a user equipment (UE), may include: means for obtaining a mathematical representation function (MRF) for the performance metric such that an optimal value for each of the at least one network parameter provides a result of zero in the MRF; means for making at least one noisy observation of the MRF from the network; and means for recursively updating the at least one network parameter based on the at least one noisy observation to obtain the optimal value for each of the at least one network parameter that provides the result of zero in the MRF. The at least one network parameter comprises one or more of a threshold parameter and a timer parameter.

An apparatus for determining, within a radio network, an optimal value of at least one network parameter having an associated performance metric, the network having at least a base station and a user equipment (UE), the apparatus includes a processor configured for: obtaining a mathematical representation function (MRF) for the performance metric such that an optimal value for each of the at least one network parameter provides a result of zero in the MRF; making at least one noisy observation of the MRF from the network; and recursively updating the at least one network parameter based on the at least one noisy observation to obtain the optimal value for each of the at least one network parameter that provides the result of zero in the MRF. The at least one network parameter comprises one or more of a threshold parameter and a timer parameter.

A computer program product for determining, within a radio network, an optimal value of at least one network parameter having an associated performance metric, the network having at least a base station and a user equipment (UE) includes a non-transitory computer-readable medium including code for: obtaining a mathematical representation function (MRF) for the performance metric such that an optimal value for each of the at least one network parameter provides a result of zero in the MRF; making at least one noisy observation of the MRF from the network; and recursively updating the at least one network parameter based on the at least one noisy observation to obtain the optimal value for each of the at least one network parameter that provides the result of zero in the MRF. The at least one network parameter comprises one or more of a threshold parameter and a timer parameter.

A method of determining, within a radio network, an optimal value of at least one network parameter having an associated performance metric, the network having at least a base station and a user equipment (UE), the method may include, but is not limited to any one or combination of: obtaining a mathematical representation function (MRF) for the performance metric such that an optimal value for each of the at least one network parameter provides a result of zero in the MRF; receiving, at the UE, a range from the base station for each of the at least one network parameter; making, via the UE, at least one noisy observation of the MRF from the network; and recursively updating the at least one network parameter within the range based on the at least one noisy observation to obtain the optimal value for each of the at least one network parameter that provides the result of zero in the MRF.

In various embodiments, the at least one network parameter comprises handover parameters.

In some embodiments, the handover parameters comprise a hysteresis parameter and a time to trigger timer parameter.

In various embodiments, the at least one network parameter is recursively updated at the UE.

An apparatus for determining, within a radio network, an optimal value of at least one network parameter having an associated performance metric, the network having at least a base station and a user equipment (UE), may include: means for obtaining a mathematical representation function (MRF) for the performance metric such that an optimal value for each of the at least one network parameter provides a result of zero in the MRF; means for receiving, at the UE, a range from the base station for each of the at least one network parameter; means for making, via the UE, at least one noisy observation of the MRF from the network; and means for recursively updating the at least one network parameter within the range based on the at least one noisy observation to obtain the optimal value for each of the at least one network parameter that provides the result of zero in the MRF.

An apparatus for determining, within a radio network, an optimal value of at least one network parameter having an associated performance metric, the network having at least a base station and a user equipment (UE), the apparatus includes a processor configured for: obtaining a mathematical representation function (MRF) for the performance metric such that an optimal value for each of the at least one network parameter provides a result of zero in the MRF; receiving, at the UE, a range from the base station for each of the at least one network parameter; making, via the UE, at least one noisy observation of the MRF from the network; and recursively updating the at least one network parameter within the range based on the at least one noisy observation to obtain the optimal value for each of the at least one network parameter that provides the result of zero in the MRF.

A computer program product for determining, within a radio network, an optimal value of at least one network parameter having an associated performance metric, the network having at least a base station and a user equipment (UE) includes a non-transitory computer-readable medium including code for: obtaining a mathematical representation function (MRF) for the performance metric such that an optimal value for each of the at least one network parameter provides a result of zero in the MRF; receiving, at the UE, a range from the base station for each of the at least one network parameter; making, via the UE, at least one noisy observation of the MRF from the network; and recursively updating the at least one network parameter within the range based on the at least one noisy observation to obtain the optimal value for each of the at least one network parameter that provides the result of zero in the MRF.

A method of determining, within a radio network, an optimal value of at least one network parameter having an associated performance metric, the network having at least a base station and a user equipment (UE), the method may include, but is not limited to any one or combination of: obtaining a mathematical representation function (MRF) for the performance metric such that an optimal value for each of the at least one network parameter provides a result of zero in the MRF; determining an environment condition of the UE from among a plurality of environment conditions including at least a first environment condition and a second environment condition; making, during the second environment condition, at least one noisy observation of the MRF from the network; and recursively updating the at least one network parameter during the second environment condition, based on the at least one noisy observation and data from a previous instance of the second environment condition, to obtain the optimal value for each of the at least one network parameter that provides the result of zero in the MRF.

In various embodiments, the first environment condition is different from the second environment condition.

In some embodiments, the first environment condition is a first mobility speed range of the UE and the second environment condition is a second mobility speed range of the UE that is greater than the first mobility speed range of the UE.

In some embodiments, the first environment condition is a first load of the network and the second environment condition is a second load of the network that is greater than the first load of the network.

In various embodiments, the data from the previous instance of the second environment condition comprises an optimal value for each of the at least one network parameter obtained during the previous instance of the second environment condition.

In various embodiments, the previous instance of the second environment condition occurs before a current instance of the second environment condition and at least one instance of the first environment condition.

In various embodiments, the at least one network parameter comprises handover parameters.

In some embodiments, the handover parameters comprise hysteresis and a time to trigger timer.

In various embodiments, the at least one network parameter is recursively updated at the UE.

In various embodiments, the at least one network parameter comprises at least one mapping parameter.

In some embodiments, the at least one mapping parameter comprises a channel quality information (CQI) to modulation coding scheme (MCS) parameter.

An apparatus for determining, within a radio network, an optimal value of at least one network parameter having an associated performance metric, the network having at least a base station and a user equipment (UE), may include: means for obtaining a mathematical representation function (MRF) for the performance metric such that an optimal value for each of the at least one network parameter provides a result of zero in the MRF; means for determining an environment condition of the UE from among a plurality of environment conditions including at least a first environment condition and a second environment condition; means for making, during the second environment condition, at least one noisy observation of the MRF from the network; and means for recursively updating the at least one network parameter during the second environment condition, based on the at least one noisy observation and data from a previous instance of the second environment condition, to obtain the optimal value for each of the at least one network parameter that provides the result of zero in the MRF.

An apparatus for determining, within a radio network, an optimal value of at least one network parameter having an associated performance metric, the network having at least a base station and a user equipment (UE), the apparatus includes a processor configured for: obtaining a mathematical representation function (MRF) for the performance metric such that an optimal value for each of the at least one network parameter provides a result of zero in the MRF; determining an environment condition of the UE from among a plurality of environment conditions including at least a first environment condition and a second environment condition; making, during the second environment condition, at least one noisy observation of the MRF from the network; and recursively updating the at least one network parameter during the second environment condition, based on the at least one noisy observation and data from a previous instance of the second environment condition, to obtain the optimal value for each of the at least one network parameter that provides the result of zero in the MRF.

A computer program product for determining, within a radio network, an optimal value of at least one network parameter having an associated performance metric, the network having at least a base station and a user equipment (UE) includes a non-transitory computer-readable medium including code for: obtaining a mathematical representation function (MRF) for the performance metric such that an optimal value for each of the at least one network parameter provides a result of zero in the MRF; determining an environment condition of the UE from among a plurality of environment conditions including at least a first environment condition and a second environment condition; making, during the second environment condition, at least one noisy observation of the MRF from the network; and recursively updating the at least one network parameter during the second environment condition, based on the at least one noisy observation and data from a previous instance of the second environment condition, to obtain the optimal value for each of the at least one network parameter that provides the result of zero in the MRF.

### BRIEF DESCRIPTION OF THE DRAWINGS

FIG. 1 is a block diagram of a wireless communication system 100 with optimized network performance according to various embodiments of the disclosure.

FIGS. 2A-2B a flow diagram illustrating a method for optimizing network performance in a wireless communication system according to various embodiments of the disclosure.

FIGS. 3A-3B is a flow diagram illustrating a method for optimizing network performance in a wireless communication system according to various embodiments of the disclosure

FIG. 4 is a graph illustrating environmental conditions over time according to various embodiments of the disclosure.

FIGS. 5A-5B is a flow diagram illustrating a method for optimizing network performance in a wireless communication system according to various embodiments of the disclosure

FIG. 6 illustrates certain components that may be included within a wireless node according to various embodiments of the disclosure.

### DETAILED DESCRIPTION

According to various embodiments, radio network performance may be optimized autonomously. In particular, a base station may be configured to determine its parameter values via stochastic approximation while observing (making “noisy” observations) network performance over time. In some embodiments, a user equipment may be configured to determine its parameters values, for instance within a range provided by the base station, in a similar manner.

A method of determining, within a radio network, an optimal value of at least one network parameter having an associated performance metric, the network having at least a base station and a user equipment (UE), may include: providing a mathematical representation function (MRF) for the performance metric such that an optimal value for each of the at least one network parameter provides a result of zero in the MRF; making at least one noisy observation of the MRF from the network; and recursively updating the at least one network parameter based on the at least one noisy observation to obtain the optimal value for each of the at least one network parameter that provides the result of zero in the MRF.

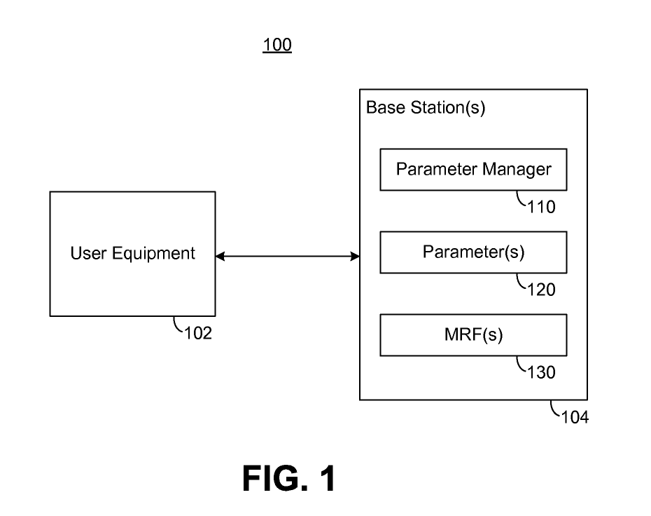

FIG. 1 is a block diagram of a wireless communication system 100 with optimized network performance. The system 100 may include a user equipment 102. Examples of the user equipment 102 include cellular phones, personal digital assistants (PDAs), handheld devices, wireless modems, laptop computers, personal computers, etc. The user equipment 102 may also be referred to as an access terminal, a mobile terminal, a mobile station, a remote station, a user terminal, a terminal, a subscriber unit, a mobile device, a wireless device, a subscriber station, a communication device, or the like.

The system 100 also includes one or more base stations 104 for communicating with the user equipment 102. The base station 104 may be referred to as an access point, a Node B, an evolved Node B (eNode B), or the like.

As shown, a parameter manager 110 is provided to analyze and dynamically adjust one or more parameters 120 that are employed by the base station 104 in providing wireless service to the user equipment 102. Although the parameter manager 110 is shown as being implemented at the base station 104, it is to be appreciated that other arrangements are possible. For example, the parameter manager 110 may be implemented at a separate entity (e.g., a different base station) from the base station 104. In some embodiments, the user equipment 102 may include one or more aspects of the parameter manager 110.

In general, the parameters 120 are monitored and controlled by the parameter manager 110 in an automated manner in order to facilitate optimization of the system 100. In general, the parameters 120 are monitored or observed (directly or indirectly) and dynamically adjusted (e.g., recursively updated) by the parameter manager 110 accordingly.

The parameters 120 may include, for example, threshold parameters (e.g., signal detection threshold, Eb/No target, etc.), timer parameters (e.g., inactivity timer, time-to-trigger timers), handover parameters (e.g., hysteresis, time-to-trigger timer, etc.), mapping parameters, and/or the like. Each parameter 120 has an associated performance metric.

A parameter 120 may be controlled by the parameter manager 110 based on a corresponding mathematical representation function (MRF) 130 for the performance metric of the parameter 120. The MRF 130 is such that a value that results in a zero of the MRF 130 is an optimal value for the parameter 120.

According to various embodiments, a stochastic approximation algorithm may be used to find a zero of a function g(θ), such as one or more of the MRFs 130, when there is only a noisy observation of the function g(θ) (i.e., there is no direct observation of the function g(θ)), such as by θₘ₊₁=θₘ+εgₘ where gₘ is a noisy observation of g(θₘ) and ε is the step size for the adaptation.

That is, the current theta estimate (θₘ) and the corresponding current noisy estimate (gₘ) of the function provide an approximation of a new zero (θₘ₊₁) of the function g(θ). Accordingly, the corresponding parameter value for the new zero may be applied to the radio network to optimize performance thereof.

For instance, in some embodiments, one of the parameters 120 is a data inactivity timer (e.g., for Cell_FACH to idle state transition). If the timer is too short, user experience is degraded; if the timer is too long, there is unnecessary resource consumption (because a new reconnection request is initiated) and increased consumption of the battery of the user equipment 102. Accordingly, the parameter manager 110 may optimize the system 100 by applying the minimum timer parameter value (timer length) that maintains the probability of reconnection request (within a time window—e.g., 20 sec) below a predetermined threshold (e.g., 5% or less). The provided MRF 130 representing the performance metric of the timer parameter value may be given as g(T_{F2I})=P_{FA}(T_{F2I})−P_{FA,target}, where P_{FA}(t) is a probability of receiving a reconnection request when T_{F2I}=t. For such a parameter 120, there may only be noisy observations of P_{FA}(T_{F2I}), but no direct observation of P_{FA}(T_{F2I}). A noisy observation of P_{FA}(Tₘ) is given by P_{FA(m)}=1, if false alarm event; 0, otherwise. The recursive algorithm becomes: Tₘ₊₁=Tₘ+ε(P_{FA(m)}−P_{FA,target}). That is, the current theta estimate (Tₘ) and the corresponding current noisy estimate (P_{FA(m)}−P_{FA,target}) of the function provide an approximation of a new zero (Tₘ₊₁) of the function g(T_{F2I}). The corresponding parameter value for the new zero of the timer parameter may be applied to the radio network to optimize performance thereof. In other embodiments, the parameters 120 may include other timers, such as a time to trigger timer, a time to wait for an event timer (e.g., maximum time to wait for a certain message), a periodicity timer, etc.

In some embodiments, one of the parameters 120 includes an Eb/No threshold (e.g., for Outer-Loop Power Control). Eb/No provides a measure of the performance of a link between the UE 102 and the base station 104. It represents the signal to noise ratio for a single bit. If the Eb/No threshold is too low, the frame error rate (FER) is too high; if the Eb/No threshold is too low, then uplink and/or downlink interference is increased. Accordingly, the parameter manager 110 may optimize the system 100 by applying the minimum Eb/No threshold that maintains the FER below a predetermined threshold. The provided MRF 130 representing the performance metric of the Eb/No threshold value may be given as g(γ)=P_{E}(γ)−P_{E,target}, where P_{E}(γ) is FER when Eb/No threshold=γ. For such a parameter 120, there may only be noisy observations of P_{E}(γ), but no direct observation of P_{E}(γ). A noisy observation of P_{E}(γₘ) is given by P_{E(m)}=1, if frame error event; 0, otherwise. The recursive algorithm becomes: γₘ₊₁=γₘ+ε(P_{E(m)}−P_{E,target}). That is, the current theta estimate (γₘ) and the corresponding current noisy estimate (P_{E(m)}−P_{E,target}) of the function provide an approximation of a new zero (γₘ₊₁) of the function g(γ). The corresponding parameter value for the new zero of the threshold parameter may be applied to the radio network to optimize performance thereof. In other embodiments, the parameters 120 may include other thresholds, such as a signal detection threshold, a clarification threshold, etc.

In some embodiments, one of the parameters 120 includes CQI (Channel Quality Information) to MCS (Modulation Coding Scheme) mapping. If the MCS mapping is too aggressive (e.g., using higher order modulation), packet error rate (PER) is increased; if the MCS is too conservative, the channel is under utilized. Accordingly, the parameter manager 110 may optimize the system 100 by mapping the CQI to the highest MCS map that maintains the PER below a predetermined value. The provided MRF 130 may be given as g(c)=P_{E target}−P_{E}(c), where P_{E}(c) is PER when a given CQI is mapped to MCS c. For such a parameter 120, there may only be noisy observations of P_{E}(c), but no direct observation of P_{E}(c). A noisy observation of P_{E}(cₘ) is given by P_{E(m)}=1, if packet error event; 0, otherwise. The recursive algorithm becomes: cₘ₊₁=cₘ+ε(P_{E,target}−P_{E(m)}). That is, the current estimate (cₘ) and the corresponding current noisy estimate (P_{E,target}−P_{E(m)}) of the function provide an approximation of a new zero (cₘ₊₁) of the function g(c). Since the mapping parameter should be an integer, cₘ₊₁ is rounded to the nearest integer and this parameter value may be applied to the radio network to optimize performance thereof.

In some embodiments, one or more of the parameters 120 includes handover (HO) parameters. HO failure rate is a function of two parameters: hysteresis (h) and time to trigger (t). The HO failure rate is given as f(h, t). FO failure rate (f(h, t)) can be minimized by finding optimal h and t. This is the equivalent of finding a zero of a gradient of f(h, t). Thus, the provided MRF 130 may be given as g(h, t)=∇f(h, t), where f(h, t) is HO failure rate for a given hysteresis (h) and time to trigger (t). Noisy estimates of ∇f(h, t) can be obtained from noisy observations of f(h, t) at the base station 104. For example, a Kiefer-Wolfowitz procedure (finite difference method) may be used to obtain the noisy estimates of ∇f(h, t). Let q(h, t) denote the noisy estimate of ∇f(h, t). The recursive algorithm becomes (hₘ₊₁, tₘ₊₁)=(hₘ, tₘ)+εq(hₘ, tₘ). That is, the current estimate (hₘ, tₘ) and the corresponding current noisy estimate (hₘ, tₘ) of the function provide an approximation of a new zero (hₘ₊₁, tₘ₊₁) of the function g(h, t). The corresponding parameter values for the new zero of the handover parameters (h and t) may be applied to the radio network to optimize performance thereof.

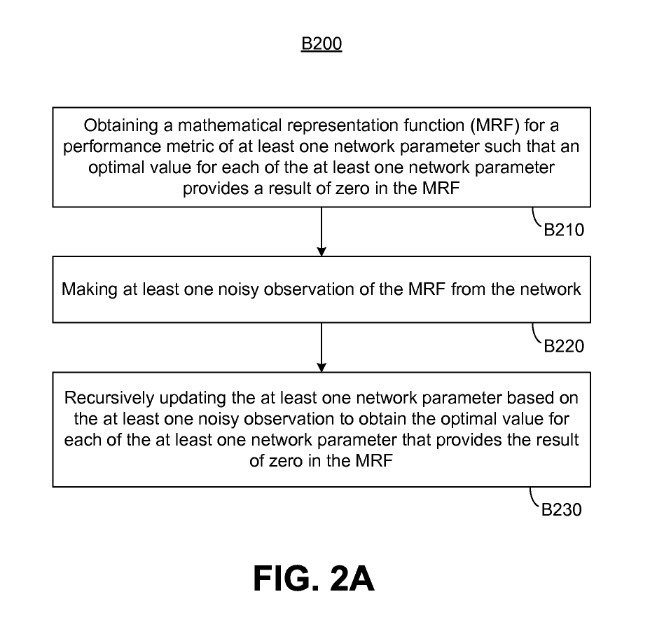

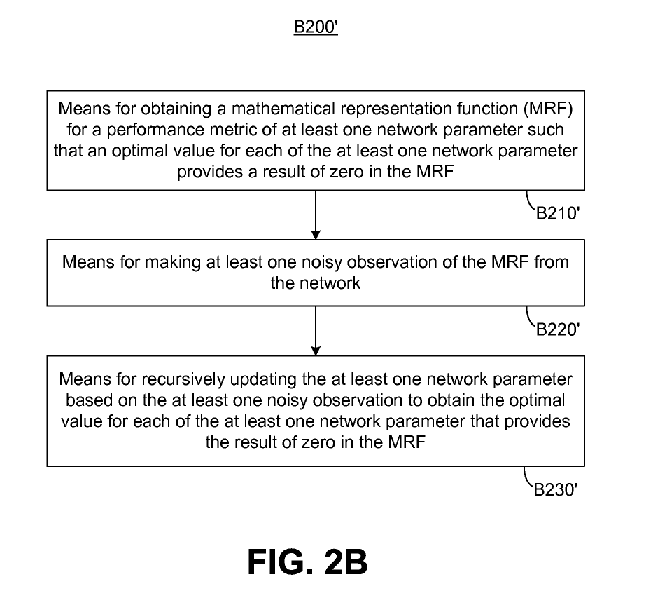

FIG. 2A is a flow diagram illustrating a method B200 for optimizing network performance in a wireless communication system (e.g., 100 in FIG. 1). With reference to FIGS. 1-2A, one or more aspects of the method B200 may be performed by the base station 104 (e.g., parameter manager 110) and/or the UE 102 to optimize at least one network parameter. The method B200 may include, at block B210, providing a mathematical representation function (MRF) for the performance metric such that an optimal value for each of the at least one network parameter provides a result of zero in the MRF. In particular embodiments, the network parameter is a threshold (e.g., Eb/No threshold, signal detection threshold, etc.), a timer (e.g., data inactivity timer, time to trigger timer, etc.), or the like. The method B200 may include, at block B220, making, via the base station 104 of the radio network (system 100), at least one noisy observation of the MRF from the network. Alternatively or in addition, the UE 102 may make such observations. The method B200 may include, at block B230, recursively updating the at least one network parameter based on the at least one noisy observation to obtain the optimal value for each of the at least one network parameter that provides the result of zero in the MRF.

The method B200 of FIG. 2A may be performed by various hardware and/or software component(s) and/or module(s) corresponding to the means-plus-function blocks B200′ illustrated in FIG. 2B. In other words, one or more of blocks B210 through B230 illustrated in FIG. 2A may correspond to one or more of means-plus-function blocks B210′ through B230′ illustrated in FIG. 2B.

With reference to FIGS. 1-2B, in some embodiments, multiple observations may be made to reduce the impact of noisy observations, for example, via an average, such as an exponential moving average: P_{FA(m)}=−αP_{FA,inst(m)}+(1−α)P_{FA(m+1)}, where P_{FA,inst(m)} is the current noisy observation.

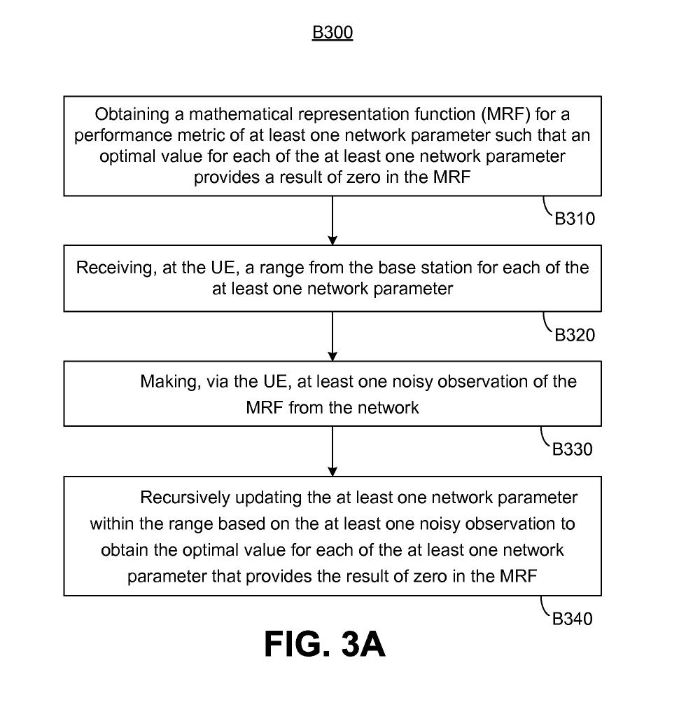

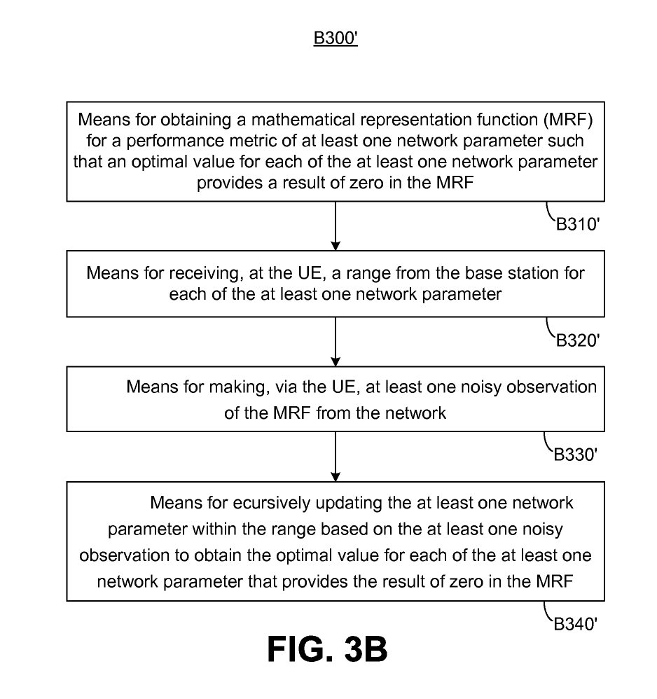

In some embodiments, the base station 104 provides a range of parameter values for the network parameter(s) (referred to as open-loop operation), and the UE 102 obtains the optimal value for the network parameter(s) within the range (referred to as closed-loop operation). For instance, FIG. 3A is a flow diagram illustrating a method B300 for optimizing network performance in a wireless communication system (e.g., 100 in FIG. 1).

With reference to FIGS. 1-3A, one or more aspects of the method B300 may be performed by the base station 104 and/or the UE 102 to optimize at least one network parameter. The method B300 may include, at block B310, obtaining a mathematical representation function (MRF) for the performance metric such that an optimal value for each of the at least one network parameter provides a result of zero in the MRF. The method B300 may include, at block B320, receiving (at the UE 102), a range from the base station 104 for each of the least one network parameter. The method B300 may include, at block B330, making, via the UE 102 of the radio network (system 100), at least one noisy observation of the MRF from the network. The method B300 may include, at block B340, recursively updating, by the UE 102, the at least one network parameter within the range received from the base station 104 based on the at least one noisy observation to obtain the optimal value for each of the at least one network parameter that provides the result of zero in the MRF

The method B300 of FIG. 3A may be performed by various hardware and/or software component(s) and/or module(s) corresponding to the means-plus-function blocks B300′ illustrated in FIG. 3B. In other words, one or more of blocks B310 through B340 illustrated in FIG. 3A may correspond to one or more of means-plus-function blocks B310′ through B340′ illustrated in FIG. 3B.

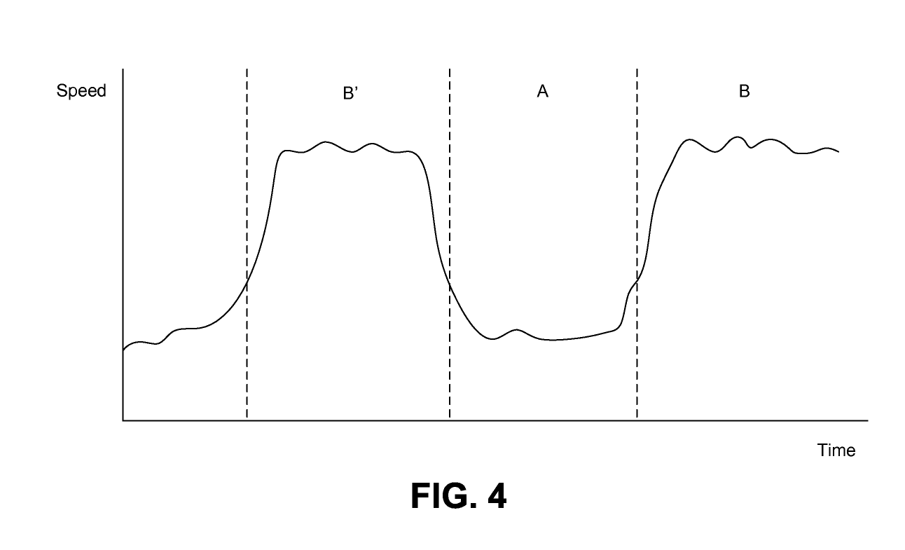

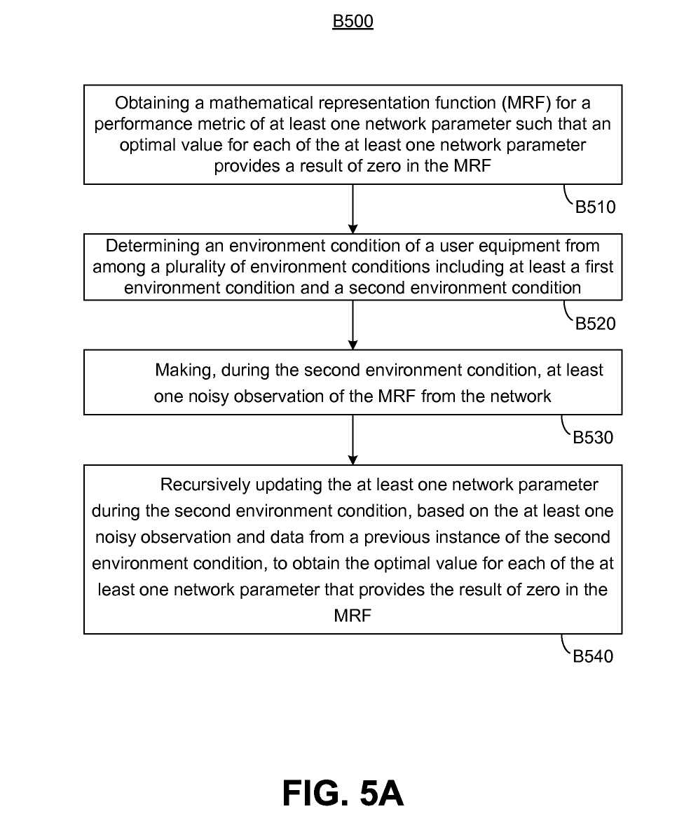

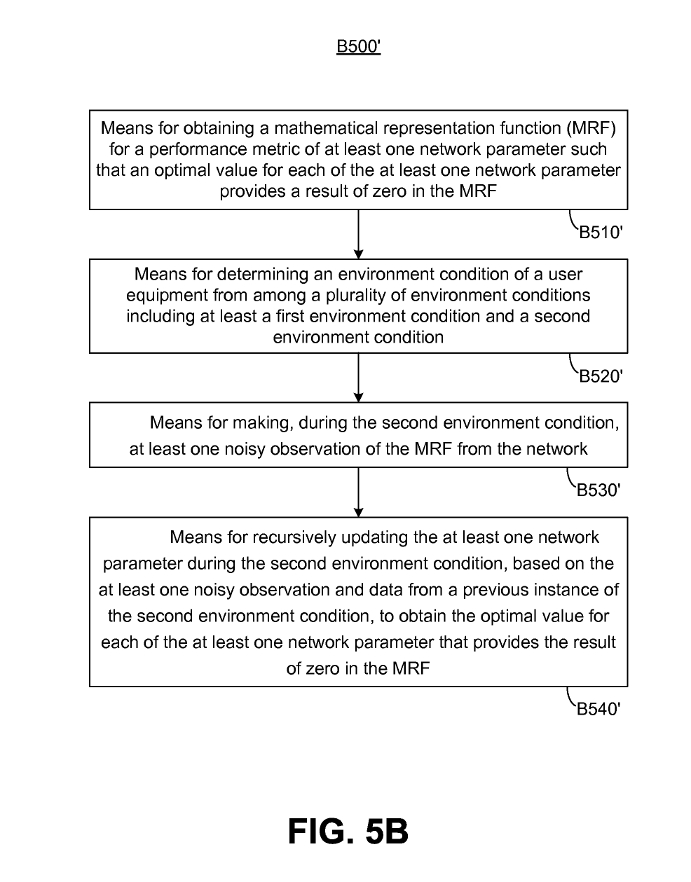

With reference to FIGS. 1-4, in some embodiments, environmental conditions in the network may change. For example, the UE 102 may be used in a first environment (e.g., phase A in FIG. 4) where the UE 102 is stationary or otherwise has a low-mobility speed (e.g., user is walking with the UE 102). Accordingly, the optimal value for the network parameter(s) may be found for the first environment condition, as discussed in the disclosure. The UE 102 may then be used in a second environment condition (e.g., phase B in FIG. 4) in which the UE 102 has a high-mobility speed (e.g., user is driving a vehicle with the UE 102). However, the network parameters in the second environment condition may be vastly different from the network parameters in the first environment condition, resulting in an increase of convergence time (i.e., time (or number of iterations)) needed to obtain the optimal value for the network parameter(s)). As such, in particular embodiments, an optimal value for the network parameter(s) may be found for the second environment condition at least based on the optimal value for the network parameter(s) in the second environment condition at a previous time (e.g., yesterday; phase B′ in FIG. 4). For instance, when in the second environment condition (e.g., upon detecting a change of environment to the second environment condition), the optimal value at such time may be based (at least) on an optimal value for the network parameter used in a previous time in which the UE 102 was in the second environment condition. This value from the previous time (in the second environment condition) may better represent current conditions of the network than those in the first environment condition. For instance, FIG. 5A is a flow diagram illustrating a method B500 for optimizing network performance in a wireless communication system (e.g., 100 in FIG. 1).

With reference to FIGS. 1-5A, one or more aspects of the method B500 may be performed by the base station 104 and/or the UE 102 to optimize at least one network parameter. The method B500 may include, at block B510, obtaining a mathematical representation function (MRF) for the performance metric such that an optimal value for each of the at least one network parameter provides a result of zero in the MRF. The method B500 may include, at block B520, determining an environment condition of the UE 102 from among a plurality of environment conditions including at least a first environment condition (e.g., phase A) and a second environment condition (e.g., phase B). Then at block B530, the method B500 may include making (e.g., by the UE 102 or the base station 104), during the second environment condition, at least one noisy observation of the MRF from the network. The method B500 may include, at block B540, recursively updating the at least one network parameter during the second environment condition, based on the at least one noisy observation and data from a previous instance of the second environment condition, to obtain the optimal value for each of the at least one network parameter that provides the result of zero in the MRF. In particular embodiments, the network parameter(s) is/are handover parameters or mapping parameters (e.g., CQI to MCS mapping parameters), or the like.

The method B500 of FIG. 5A may be performed by various hardware and/or software component(s) and/or module(s) corresponding to the means-plus-function blocks B500′ illustrated in FIG. 5B. In other words, one or more of blocks B510 through B540 illustrated in FIG. 5A may correspond to one or more of means-plus-function blocks B510′ through B540′ illustrated in FIG. 5B.

With reference to FIGS. 1-5B, as another example, the UE 102 may be used in a first environment condition in which the load on the network is relatively low, and then the UE 102 may be used in a second environment condition in which the load on the network is relatively high. Accordingly, a subsequent instance in which the UE 102 is in the first environment condition, the network parameter(s) may be optimized for the UE 102 while in the first environment condition based on the optimal network parameters during a previous instance in which the UE 102 was used in the first environment condition. Likewise, a subsequent instance in which the UE 102 is in the second environment condition, the network parameter(s) may be optimized for the UE 102 while in the second environment condition based on the optimal network parameters during a previous instance in which the UE 102 was used in the second environment condition.

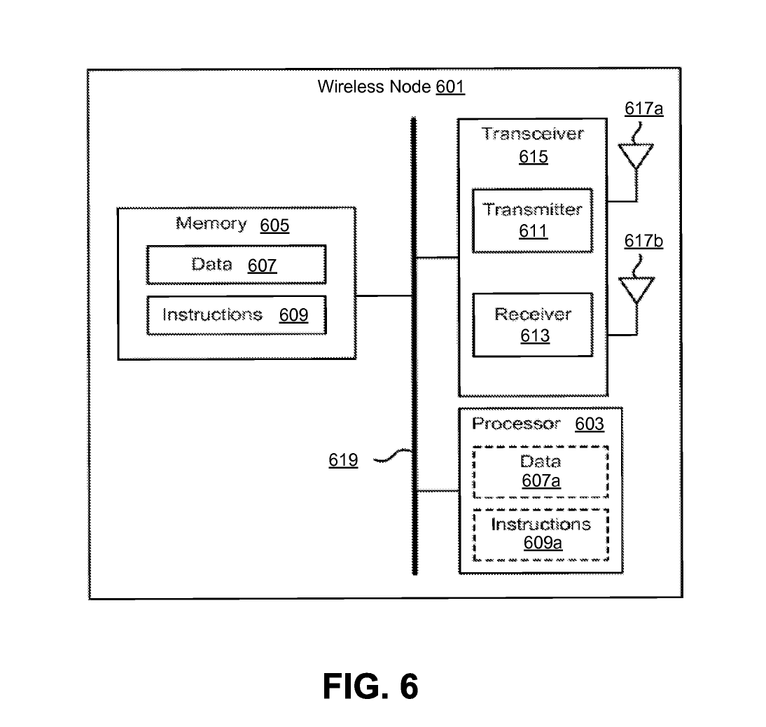

FIG. 6 illustrates certain components that may be included within a wireless node 601. With reference to FIGS. 1-6, the wireless node 601 may be the UE 102, the base station 104, or both.

The wireless node 601 may include a processor 603. The processor 603 may be a general purpose single- or multi-chip microprocessor (e.g., an ARM), a special purpose microprocessor (e.g., a digital signal processor (DSP)), a microcontroller, a programmable gate array, etc. The processor 603 may be referred to as a central processing unit (CPU). Although just a single processor 603 is shown in the wireless node 601, in an alternative configuration, a combination of processors (e.g., an ARM and DSP) could be used.

The wireless node 601 may include memory 605. The memory 605 may be any electronic component capable of storing electronic information. The memory 605 may be embodied as random access memory (RAM), read only memory (ROM), magnetic disk storage media, optical storage media, flash memory devices in RAM, on-board memory included with the processor, EPROM memory, EEPROM memory, registers, and so forth, including combinations thereof.

Data 607 and instructions 609 may be stored in the memory 605. The instructions 609 may be executable by the processor 603 to implement the methods disclosed herein. Executing the instructions 609 may involve the use of the data 607 that is stored in the memory 605. When the processor 603 executes the instructions 607, various portions of the instructions 609a may be loaded onto the processor 603, and various pieces of data 607a may be loaded onto the processor 603.

The wireless node 601 may also include a transmitter 611 and a receiver 613 to allow transmission and reception of signals between the wireless node 601 and a remote location. The transmitter 611 and receiver 613 may be collectively referred to as a transceiver 615. An antenna 617 may be electrically coupled to the transceiver 615. The wireless node 601 may also include (not shown) multiple transmitters, multiple receivers, multiple transceivers and/or multiple antenna.

The various components of the wireless node 601 may be coupled together by one or more buses, which may include a power bus, a control signal bus, a status signal bus, a data bus, etc. For the sake of clarity, the various buses are shown as bus system 619.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. In addition, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method of determining, within a radio network, an optimal value of at least one network parameter having an associated performance metric, the network having at least a base station and a user equipment (UE), the method comprising:
obtaining a mathematical representation function (MRF) for the performance metric such that an optimal value for each of the at least one network parameter provides a result of zero in the MRF;
making at least one noisy observation of the MRF from the network; and
recursively updating the at least one network parameter based on the at least one noisy observation to obtain the optimal value for each of the at least one network parameter that provides the result of zero in the MRF;
wherein the at least one network parameter comprises one or more of a threshold parameter and a timer parameter.

2. The method of claim 1, wherein the threshold parameter is an Eb/No target threshold parameter.

3. The method of claim 1, wherein the threshold parameter is a signal detection threshold parameter.

4. The method of claim 1, wherein the timer parameter is a data inactivity timer parameter.

5. The method of claim 4, wherein the data inactivity timer comprises a data inactivity timer for Cell_FACH to idle state transition.

6. The method of claim 1, wherein the timer parameter is a time to trigger timer parameter.

7. The method of claim 1, wherein the at least one noisy observation is made by the UE.

8. The method of claim 1, wherein the at least one noisy observation is made by the base station.

9. The method of claim 1, wherein the at least one network parameter is recursively updated at the base station.

10. The method of claim 1, wherein the at least one network parameter is recursively updated at the UE.

11. The method of claim 1, wherein the at least one noisy observation is an average of more than one noisy observations.

12. An apparatus for determining, within a radio network, an optimal value of at least one network parameter having an associated performance metric, the network having at least a base station and a user equipment (UE), the apparatus comprising:
means for obtaining a mathematical representation function (MRF) for the performance metric such that an optimal value for each of the at least one network parameter provides a result of zero in the MRF;
means for making at least one noisy observation of the MRF from the network; and
means for recursively updating the at least one network parameter based on the at least one noisy observation to obtain the optimal value for each of the at least one network parameter that provides the result of zero in the MRF;
wherein the at least one network parameter comprises one or more of a threshold parameter and a timer parameter.

13. An apparatus for determining, within a radio network, an optimal value of at least one network parameter having an associated performance metric, the network having at least a base station and a user equipment (UE), the apparatus comprising:
a processor configured for:
obtaining a mathematical representation function (MRF) for the performance metric such that an optimal value for each of the at least one network parameter provides a result of zero in the MRF;
making at least one noisy observation of the MRF from the network; and
recursively updating the at least one network parameter based on the at least one noisy observation to obtain the optimal value for each of the at least one network parameter that provides the result of zero in the MRF;
wherein the at least one network parameter comprises one or more of a threshold parameter and a timer parameter.

14. A computer program product for determining, within a radio network, an optimal value of at least one network parameter having an associated performance metric, the network having at least a base station and a user equipment (UE), the computer program product comprising:
a non-transitory computer-readable medium comprising code for:
obtaining a mathematical representation function (MRF) for the performance metric such that an optimal value for each of the at least one network parameter provides a result of zero in the MRF;
making at least one noisy observation of the MRF from the network; and
recursively updating the at least one network parameter based on the at least one noisy observation to obtain the optimal value for each of the at least one network parameter that provides the result of zero in the MRF;
wherein the at least one network parameter comprises one or more of a threshold parameter and a timer parameter.

15. A method of determining, within a radio network, an optimal value of at least one network parameter having an associated performance metric, the network having at least a base station and a user equipment (UE), the method comprising:
obtaining a mathematical representation function (MRF) for the performance metric such that an optimal value for each of the at least one network parameter provides a result of zero in the MRF;
receiving, at the UE, a range from the base station for each of the at least one network parameter;
making, via the UE, at least one noisy observation of the MRF from the network; and
recursively updating the at least one network parameter within the range based on the at least one noisy observation to obtain the optimal value for each of the at least one network parameter that provides the result of zero in the MRF.

16. The method of claim 15, wherein the at least one network parameter comprises handover parameters.

17. The method of claim 16, wherein the handover parameters comprise a hysteresis parameter and a time to trigger timer parameter.

18. The method of claim 15, wherein the at least one network parameter is recursively updated at the UE.

19. An apparatus for determining, within a radio network, an optimal value of at least one network parameter having an associated performance metric, the network having at least a base station and a user equipment (UE), the apparatus comprising:
means for obtaining a mathematical representation function (MRF) for the performance metric such that an optimal value for each of the at least one network parameter provides a result of zero in the MRF;
means for receiving, at the UE, a range from the base station for each of the at least one network parameter;
means for making, via the UE, at least one noisy observation of the MRF from the network; and
means for recursively updating the at least one network parameter within the range based on the at least one noisy observation to obtain the optimal value for each of the at least one network parameter that provides the result of zero in the MRF.

20. An apparatus for determining, within a radio network, an optimal value of at least one network parameter having an associated performance metric, the network having at least a base station and a user equipment (UE), the apparatus comprising:
a processor configured for:
obtaining a mathematical representation function (MRF) for the performance metric such that an optimal value for each of the at least one network parameter provides a result of zero in the MRF;
receiving, at the UE, a range from the base station for each of the at least one network parameter;
making, via the UE, at least one noisy observation of the MRF from the network; and
recursively updating the at least one network parameter within the range based on the at least one noisy observation to obtain the optimal value for each of the at least one network parameter that provides the result of zero in the MRF.

21. A computer program product for determining, within a radio network, an optimal value of at least one network parameter having an associated performance metric, the network having at least a base station and a user equipment (UE), the computer program product comprising:
a non-transitory computer-readable medium comprising code for:
obtaining a mathematical representation function (MRF) for the performance metric such that an optimal value for each of the at least one network parameter provides a result of zero in the MRF;
receiving, at the UE, a range from the base station for each of the at least one network parameter;
making, via the UE, at least one noisy observation of the MRF from the network; and
recursively updating the at least one network parameter within the range based on the at least one noisy observation to obtain the optimal value for each of the at least one network parameter that provides the result of zero in the MRF.

22. A method of determining, within a radio network, an optimal value of at least one network parameter having an associated performance metric, the network having at least a base station and a user equipment (UE), the method comprising:
obtaining a mathematical representation function (MRF) for the performance metric such that an optimal value for each of the at least one network parameter provides a result of zero in the MRF;
determining an environment condition of the UE from among a plurality of environment conditions including at least a first environment condition and a second environment condition;
making, during the second environment condition, at least one noisy observation of the MRF from the network; and
recursively updating the at least one network parameter during the second environment condition, based on the at least one noisy observation and data from a previous instance of the second environment condition, to obtain the optimal value for each of the at least one network parameter that provides the result of zero in the MRF.

23. The method of claim 22, wherein the first environment condition is different from the second environment condition.

24. The method of claim 23, wherein the first environment condition is a first mobility speed range of the UE and the second environment condition is a second mobility speed range of the UE that is greater than the first mobility speed range of the UE.

25. The method of claim 23, wherein the first environment condition is a first load of the network and the second environment condition is a second load of the network that is greater than the first load of the network.

26. The method of claim 22, wherein the data from the previous instance of the second environment condition comprises an optimal value for each of the at least one network parameter obtained during the previous instance of the second environment condition.

27. The method of claim 22, wherein the previous instance of the second environment condition occurs before a current instance of the second environment condition and at least one instance of the first environment condition.

28. The method of claim 22, wherein the at least one network parameter comprises handover parameters.

29. The method of claim 28, wherein the handover parameters comprise hysteresis and a time to trigger timer.

30. The method of claim 22, wherein the at least one network parameter is recursively updated at the UE.

31. The method of claim 22, wherein the at least one network parameter comprises at least one mapping parameter.

32. The method of claim 31, wherein the at least one mapping parameter comprises a channel quality information (CQI) to modulation coding scheme (MCS) parameter.

33. An apparatus for determining, within a radio network, an optimal value of at least one network parameter having an associated performance metric, the network having at least a base station and a user equipment (UE), the apparatus comprising:
means for obtaining a mathematical representation function (MRF) for the performance metric such that an optimal value for each of the at least one network parameter provides a result of zero in the MRF;
means for determining an environment condition of the UE from among a plurality of environment conditions including at least a first environment condition and a second environment condition;
means for making, during the second environment condition, at least one noisy observation of the MRF from the network; and
means for recursively updating the at least one network parameter during the second environment condition, based on the at least one noisy observation and data from a previous instance of the second environment condition, to obtain the optimal value for each of the at least one network parameter that provides the result of zero in the MRF.

34. An apparatus for determining, within a radio network, an optimal value of at least one network parameter having an associated performance metric, the network having at least a base station and a user equipment (UE), the apparatus comprising:
a processor configured for:
obtaining a mathematical representation function (MRF) for the performance metric such that an optimal value for each of the at least one network parameter provides a result of zero in the MRF;
determining an environment condition of the UE from among a plurality of environment conditions including at least a first environment condition and a second environment condition;
making, during the second environment condition, at least one noisy observation of the MRF from the network; and
recursively updating the at least one network parameter during the second environment condition, based on the at least one noisy observation and data from a previous instance of the second environment condition, to obtain the optimal value for each of the at least one network parameter that provides the result of zero in the MRF.

35. A computer program product for determining, within a radio network, an optimal value of at least one network parameter having an associated performance metric, the network having at least a base station and a user equipment (UE), the computer program product comprising:
a non-transitory computer-readable medium comprising code for:
obtaining a mathematical representation function (MRF) for the performance metric such that an optimal value for each of the at least one network parameter provides a result of zero in the MRF;
determining an environment condition of the UE from among a plurality of environment conditions including at least a first environment condition and a second environment condition;
making, during the second environment condition, at least one noisy observation of the MRF from the network; and
recursively updating the at least one network parameter during the second environment condition, based on the at least one noisy observation and data from a previous instance of the second environment condition, to obtain the optimal value for each of the at least one network parameter that provides the result of zero in the MRF.
